(19) United States
(12) Patent Application Publication
(10) Pub. No.: US 2025/0125475 A1
(43) Pub. Date: Apr. 17, 2025

(54) BATTERY PACK FOR VEHICLE

(71) Applicants: HYUNDAI MOTOR COMPANY, SEOUL (KR); KIA CORPORATION, SEOUL (KR)

(72) Inventors: Kyung Mo Kim, Hwaseong-si (KR); Gun Woo Ko, Seongnam-si (KR)

(21) Appl. No.: 18/606,286

(22) Filed: Mar. 15, 2024

(30) Foreign Application Priority Data
Oct. 11, 2023 (KR) 10-2023-0135208

(51) Int. Cl. H01M 50/289; H01M 50/204; H01M 50/249; H01M 50/507; H01M 50/517

(52) U.S. Cl. CPC H01M 50/289; H01M 50/204; H01M 50/249; H01M 50/507; H01M 50/517; H01M 2220/20

(57) ABSTRACT

A battery pack for a vehicle includes a lower casing in which a terminal part of a battery module and a terminal part of another battery module adjust to each other in a width direction face each other and a plurality of battery modules are placed to be sequential in a longitudinal direction, a first cross member crossing the lower casing in the width direction and inserted between battery modules among the plurality of battery modules, which are placed adjacent to each other in the longitudinal direction, and a second cross member crossing the lower casing in the longitudinal direction, fastened to an upper end of the first cross member so as to be provided between battery modules among the plurality of battery modules, which are arranged adjacent to each other in the width direction, and electrically connected to the terminal part of the battery module.

### CROSS REFERENCE TO RELATED APPLICATIONS

The present application claims priority to Korean Patent Application No. 10-2023-0135208, filed Oct. 11, 2023, the entire contents of which is incorporated herein for all purposes by this reference.

### BACKGROUND

### 1. Technical Field

The present disclosure relates to a structure of a battery pack mounted to a vehicle.

### 2. Background

Electric vehicles, etc. are equipped with an electric motor to generate a driving force of a vehicle, and a battery pack is mounted thereto to provide power to be provided to the electric motor.

The battery pack may consist of multiple battery modules mounted thereto, and each battery module may consist of multiple battery cells that are stacked on each other.

A main factor that affects the driving range of a vehicle equipped with the battery pack is a volume ratio of the battery cells mounted in the vehicle. In other words, when as many battery cells or battery modules as possible are mounted in the space forming the battery pack, a cruising range of a vehicle can be increased.

Currently, as battery cells, battery modules, and battery packs are each modularized and covers and housings are provided, the area ratio of ancillary parts, such as mechanical components for mechanical rigidity, heat dissipation/cooling components for battery cooling, and components for insulation from the outside, is larger than the volume ratio of the battery cells, causing a problem in that it is disadvantageous in securing the cruising range of a vehicle.

Therefore, there is a need to minimize overlap of mechanical rigidity functions between battery cells, battery modules, and battery packs, and there is a need to maximize the volume ratio of battery cells while maintaining the same cooling performance, insulation performance, and durability performance as before by applying integrated components with multiple functions such as a cooling function, a cell housing function, and a mechanical rigidity function.

The description provided above as a related art of the present disclosure is just for helping understand the background of the present disclosure and should not be construed as being included in the related art known by those skilled in the art.

### SUMMARY

The present disclosure is proposed to solve the above problems, and the present disclosure is intended to provide a battery pack for a vehicle, the structure of the battery pack being capable of maximizing the number of battery cells mounted to the battery pack and sufficiently securing structural rigidity of the battery pack.

The technical problems of the present disclosure are not limited to those mentioned above, and other problems not mentioned will be clearly understood by those skilled in the art from the description below.

In order to achieve the objective of the present disclosure, a battery pack for a vehicle according to the present disclosure includes a lower casing in which a terminal part of a battery module and a terminal part of another battery module adjust to each other in a width direction may face each other, and a plurality of battery modules may be placed to be sequential in a longitudinal direction; a first cross member crossing the lower casing in the width direction, and inserted between the battery modules placed adjacent to each other in the longitudinal direction, and a second cross member crossing the lower casing in the longitudinal direction, fastened to an upper end of the first cross member so as to be provided between the battery modules arranged adjacent to each other in the width direction and electrically connected to the terminal part of the battery module.

The battery modules arranged adjacent to each other in the width direction may be spaced apart from each other at a predetermined distance to form a gap space, and the second cross member may be arranged by being inserted into an upper portion of the gap space.

The upper end of the first cross member may have an indentation part having a depressed form and the indentation part may be formed at a location corresponding to the second cross member, and the second cross member may be placed in the indentation part and is fastened to the first cross member.

The second cross member may cover the gap space formed between the battery modules arranged adjacent to each other in the width direction.

The battery module may include the terminal part and a sensing connector at an upper portion of a side surface facing the second cross member, the second cross member may include a sensing device monitoring the battery module and a high-voltage bus bar connecting the battery module to another battery module adjacent to each other among the plurality of battery modules, and when the first cross member and the second cross member may be fastened to each other, the sensing device and the sensing connector may be connected to each other and the high-voltage bus bar and the terminal part may be connected to each other.

An upper portion and a rear portion of a side surface of the battery module may include respective terminal parts and the sensing connector may be provided between the front and rear terminal parts, and a front portion and a rear portion of the second cross member may include respective high-voltage bus bars to correspond to the terminal parts of the battery module and the sensing device may be provided between the front and rear high-voltage bus bars.

The battery modules arranged adjacent to each other in the longitudinal direction may be arranged such that respective terminal parts thereof may be adjacent to the first cross member, and the high-voltage bus bar may connect the terminal parts of the different battery modules adjacent to the first cross member, to each other.

The second cross member may include a member body extending in the longitudinal direction of the lower casing, and to which the sensing device and the high-voltage bus bar may be mounted, and a cover plate extending in the longitudinal direction of the lower casing and covering an upper portion of the member body.

The member body may be formed of a plastic material and the cover plate may be formed of a metal material.

The battery modules arranged adjacent to each other in the longitudinal direction may be arranged such that respective terminal parts thereof may be adjacent to the first cross member, and the high-voltage bus bar may connect the terminal parts of the different battery modules adjacent to the first cross member, to each other, and a terminal fastening bolt fastening the high-voltage bus bar and the terminal part to each other may be inserted into the member body, and a plastic insulating cover may be provided between the terminal fastening bolt inserted in the member body and the cover plate.

The high-voltage bus bar may be insulated from the cover plate by being covered with the member body.

A bushing may be integrally molded in the member body at a location adjacent in the longitudinal direction to a location into which the terminal fastening bolt may be inserted, and the cover plate may be fastened to the upper end of the first cross member by a bolting manner via the bushing together with the member body.

The member body may include the bushing that may be integrally molded at a location between locations into which the terminal fastening bolt and another terminal fastening bolt may be inserted.

The high-voltage bus bar may include an inserting part into which the terminal fastening bolt may be inserted and a connecting part connected to the inserting part while bypassing the bushing.

According to the above description, the battery pack for a vehicle of the present disclosure can maximize the number of battery cells mounted to the battery pack to maximize a cruising range of a vehicle.

Even if subordinate components are reduced, the structural rigidity of the battery pack can be sufficiently secured by the first cross member and the second cross member inserted between the battery modules, and therefore the structural safety can be improved.

As the first cross member is inserted and the second cross member is fastened to the first cross member at the upper portion of the first cross member, connection between the first cross member and the second cross member can be secured.

The effect of the present disclosure is not limited to that described above, and other effects not mentioned will be clearly understood by those skilled in the art from the description below.

### BRIEF DESCRIPTION OF THE FIGURES

FIG. 1 is an exploded-perspective view showing a battery pack for a vehicle according to an embodiment of the present disclosure.

FIG. 2 is a perspective view showing a second cross member according to an embodiment of the present disclosure.

FIG. 3 is an exploded perspective view showing an enlarged part A of FIG. 2.

FIG. 4 is a perspective view showing the battery pack for a vehicle with an opened upper cover according to an embodiment of the present disclosure.

FIG. 5 is a view showing the second cross member placed on a lower casing in which a battery module and a first cross member are placed according to an embodiment of the present disclosure.

FIG. 6 is a view showing an enlarged part B of FIG. 4.

FIG. 7 is a sectional view taken along line I-I of FIG. 4.

FIG. 8 is a sectional view taken along line II-II of FIG. 4.

### DETAILED DESCRIPTION

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

Hereafter, an embodiment of the present disclosure will be described in detail with reference to the accompanying drawings and the same or similar components are given the same reference numerals regardless of the numbers of figures and are not repeatedly described.

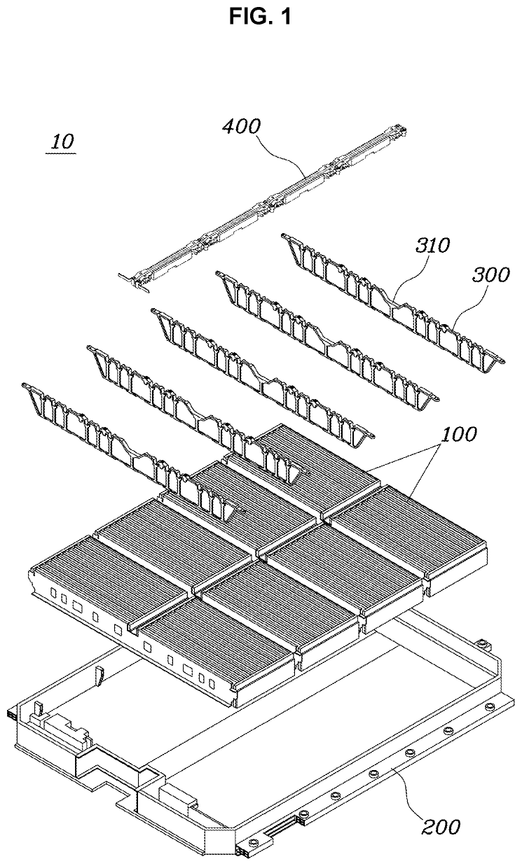

First, components of a battery pack for a vehicle according to an embodiment of the present disclosure will be described with reference to FIG. 1.

FIG. 1 is an exploded-perspective view showing a battery pack for a vehicle according to an embodiment of the present disclosure.

Referring to FIG. 1, according to the embodiment of the present disclosure, the battery pack 10 for a vehicle may include a battery module 100, a lower casing 200, a first cross member 300, and a second cross member 400. FIG. 1 mainly shows the components related to the embodiment of the present disclosure and may include fewer or more components than the actual components.

Hereinbelow, each component will be described.

The battery module that has been mounted to the conventional battery pack is a battery module surrounded by a separated housing with a plurality of battery cells being stacked. One battery pack includes a plurality of battery modules that are mounted to a casing. However, in this case, since a cover and housing are provided for each battery module, a relatively larger space is necessary to form a battery pack consisting of a predetermined quantity of battery modules and there is a problem in that a small quantity of battery modules are mounted to provide a battery pack of a preset size.

To solve the above problem, the present disclosure is intended to provide the battery pack 10 for a vehicle in a cell-to-pack method in which a battery module process is omitted. Accordingly, the battery module 100 to be described below may be provided while multiple battery cells are stacked together and are not surrounded with a housing.

The above-described battery module 100 may include multiple battery modules 100, and the multiple battery modules 100 may be placed in the lower casing 200. Specifically, the lower casing 200 may have a space in which the multiple battery modules 100 are placed, and the multiple battery modules 100 may be placed in the space. For example, the multiple battery modules 100 may be arranged such that respective terminal parts of battery modules adjacent to each other in a width direction face each other, and the multiple battery modules 100 may be placed in the lower casing 200 to be sequential in a longitudinal direction. However, this configuration is proposed as an example and is not limited thereto.

When the multiple battery modules 100 are placed in the lower casing 200, the first cross member 300 may be inserted between the placed multiple battery modules. For example, the first cross member 300 may be arranged between battery modules placed adjacent to each other in the longitudinal direction and cross the lower casing 200 in the width direction. The first cross member 300 may be arranged between the battery modules adjacent to each other in the longitudinal direction and be fastened to the lower casing 200.

Furthermore, when the first cross member 300 is inserted, the second cross member 400 may be provided between battery modules arranged adjacent to each other in the width direction.

However, in the configuration of the conventional battery pack 10, the first cross member 300 or the second cross member 400 is provided by being welded to the lower casing 200 in advance, and therefore, the multiple battery modules 100 are inserted, and a remaining first cross member 300 or second cross member 400 is inserted. In other words, the conventional battery pack has a problem in that disconnection of the first cross member 300 or the second cross member 400 occurs, resulting in a problem of deteriorating structural rigidity in the longitudinal direction or the width direction.

To solve this problem, the battery pack 10 of the present disclosure may secure connectivity between the first cross member 300 and the second cross member 400 without disconnection and may include the first cross member 300 and the second cross member 400 which can improve the structural rigidity. For example, the battery pack 10 according to the embodiment of the present disclosure may include the first cross member 300, which may cross the lower casing 200 in the width direction and be inserted between the battery modules placed adjacent to each other in the longitudinal direction, and the second cross member 400 crossing the lower casing 200 in the longitudinal direction and fastened to an upper end of the first cross member 300 to be provided between the battery modules arranged adjacent to each other in the width direction.

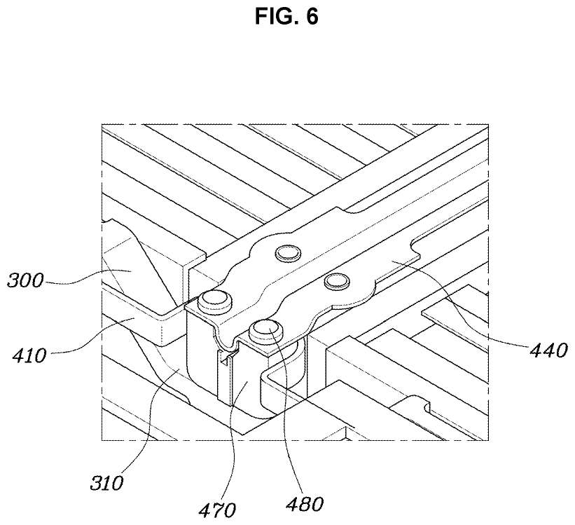

To fasten the first cross member 300 and the second cross member 400 to each other, the upper end of the first cross member 300 has an indentation part 310 of a depressed form formed at a location corresponding to the second cross member 400, and the second cross member 400 is placed on the indentation part 310 to be fastened to the first cross member 300. The fastening between the first cross member 300 and the second cross member 400 will be described in detail with reference to FIG. 6.

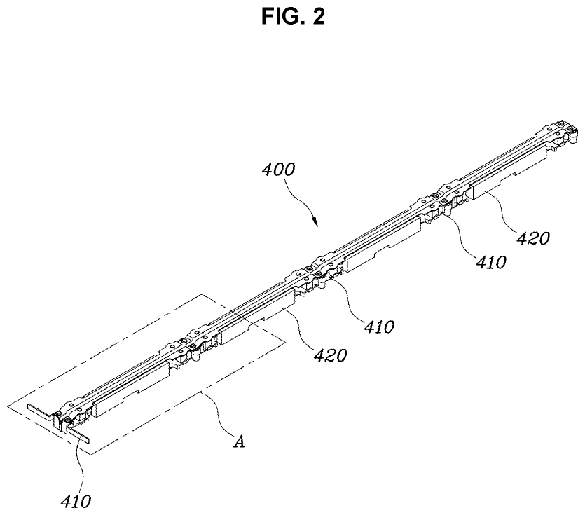

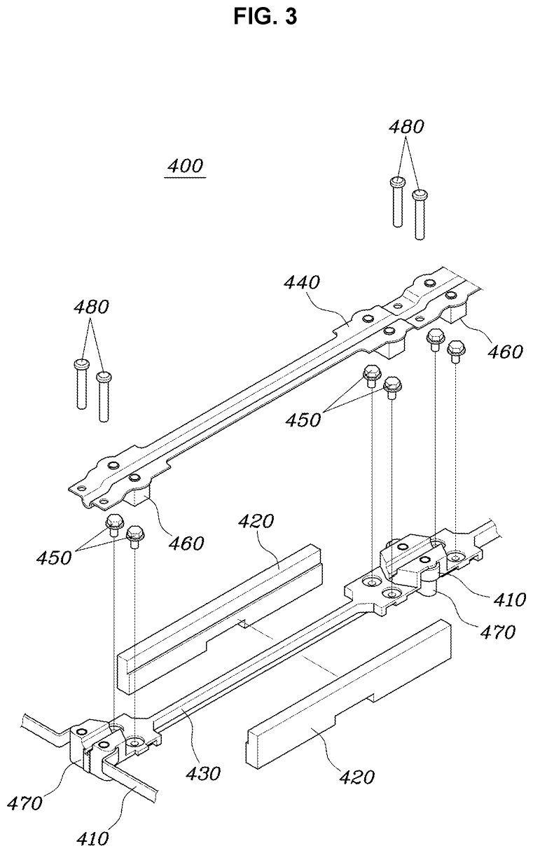

Hereinbelow, the second cross member 400 according to an embodiment of the present disclosure will be described with reference to FIGS. 2 and 3.

FIG. 2 is a perspective view showing the second cross member according to an embodiment of the present disclosure. FIG. 3 is an exploded perspective view showing an enlarged part A of FIG. 2.

First, referring to FIG. 2, the second cross member 400 according to the embodiment of the present disclosure may include a high-voltage bus bar 410 connecting adjacent battery modules placed in the lower casing 200 to each other and a sensing device 420 monitoring the battery modules 100. For example, the sensing device 420 may be a cell monitoring unit (CMU) provided to monitor the battery modules 100, but it is obvious that the present disclosure is not limited thereto.

Furthermore, as the multiple battery modules 100 are placed in the lower casing 200, the second cross member 400 may include the high-voltage bus bar 410 connecting adjacent battery modules, at a front portion and a rear portion of the second cross member 400. Furthermore, depending on a location where the adjacent battery modules are connected to each other, the second cross member 400 may include multiple high-voltage bus bars in a longitudinal direction of the second cross member 400. Meanwhile, the sensing device 420 may be provided between the front and rear high-voltage bus bars 410 or may be provided at each gap between the multiple high-voltage bus bars.

Components of the second cross member 400 will be described with reference to FIG. 3.

Referring to FIG. 3, in addition to the high-voltage bus bar 410 and the sensing device 420 described above, the second cross member 400 may include a member body 430, a cover plate 440, a terminal fastening bolt 450, an insulating cover 460, a bushing 470, and a fixing bolt 480. FIG. 3 mainly shows the components related to the embodiment of the present disclosure and may include fewer or more components than the actual components.

Hereinbelow, each component will be described.

The member body 430 may extend in the longitudinal direction of the lower casing 200, and the high-voltage bus bar 410 and the sensing device 420 may be mounted thereto. For example, the member body 430 may be formed of a plastic material and may be molded by an injection method. However, this configuration is proposed as an example and is not limited thereto.

The cover plate 440 may cover the member body 430 above the member body 430. For example, the cover plate 440 may be formed of a metal material and may be molded by an injection method or a press method. However, this configuration is proposed as an example and is not limited thereto.

The member body 430 may have a seating surface (not shown) to which the high-voltage bus bar 410 is mounted, and the high-voltage bus bar 410 may be covered with the member body 430. Accordingly, the cover plate 440 covering the upper portion of the member body 430 and the high-voltage bus bar 410 may be insulated from each other.

Furthermore, the sensing device 420 may be mounted between locations where the high-voltage bus bars 410 of the member body 430 are mounted. For example, a side surface of the sensing device 420, the surface facing the member body 430, may have a curved portion (not shown) formed to correspond to the form of the member body 430. As the curved portion and the member body 430 are bonded by a separate adhesive element, the sensing device 420 may be mounted to the member body 430. However, this configuration is proposed as an example and is not limited thereto. For example, a coupling structure is formed at each of the side surface of the sensing device 420 facing the member body 430 and the member body 430 for coupling between the sensing device and the member body, or an inserting structure is formed at the side surface of the sensing device 420 facing the member body 430 so that the sensing device 420 and the member body 430 may be assembled to each other.

In addition, the cover plate 440 may cover the member body 430 and a part of the sensing device 420 mounted to the member body 430 above the member body 430 and the sensing device 420.

Furthermore, the terminal fastening bolt 450 may be inserted into the member body 430 to fasten the high-voltage bus bar 410 and the battery module 100 to each other. For example, the terminal fastening bolt 450 may fasten the high-voltage bus bar 410 and a terminal part 110 of the battery module 100 to each other. The fastening will be described below. As the terminal fastening bolt 450 is inserted, a fixed location of the high-voltage bus bar 410 mounted to the member body 430 may be secured.

Furthermore, as the terminal fastening bolt 450 fastens the high-voltage bus bar 410 and the battery module 100 to each other, a current passing through the terminal fastening bolt 450 may also pass through the cover plate 440 located at an upper portion of the terminal fastening bolt 450, and in this case, problems may occur in the safety of the battery pack 10. To prevent the problem, the insulating cover 460 formed of plastic material for insulation may be provided between the terminal fastening bolt 450 inserted in the member body 430 and the cover plate 440. For example, the insulating cover 460 may be molded on a location in the cover plate 440 downwards in an insert injection method, the location corresponding to a location where the terminal fastening bolt 450 is inserted into the member body 430. However, this configuration is proposed as an example and is not limited thereto.

In addition, the bushing 470 may be formed at the member body 430. The bushing 470 may be integrally molded with the member body 430 at a location longitudinally adjacent to the location where the terminal fastening bolt 450 is inserted. Furthermore, when multiple locations where terminal fastening bolts 450 are inserted are provided, the bushing 470 may be integrally molded with the member body 430 at a location between the multiple locations where the terminal fastening bolts 450 are inserted.

In addition, as the bushing 470 is formed at the member body 430, the cover plate 440 may be bolted to the upper end of the first cross member 300 via the bushing 470 together with the member body 430. For example, the second cross member 400 may include the fixing bolt 480 passing through both the cover plate 440 and the bushing 470, and the fixing bolt 480 may bolt the cover plate 440 and the member body 430 to the upper end of the first cross member 300. At this point, a location where bolting is performed on the upper end of the first cross member 300 may include a fastening tap (not shown), and as the fixing bolt 480 is fastened to the fastening tap formed on the upper end of the first cross member 300, the second cross member 400 and the first cross member 300 may be fastened to each other.

Meanwhile, as the bushing 470 is integrally molded with the member body 430, the form of the high-voltage bus bar 410 mounted to the member body 430 may be changed. For example, the high-voltage bus bar 410 may include an inserting part 411 into which the terminal fastening bolt 450 is inserted and a connecting part 412 connected to the inserting part 411. At this point, as an inserted location of the terminal fastening bolt 450 is located at one side portion or both side portions of the bushing 470, the connecting part 412 may bypass the bushing 470 to be connected to the inserting part 411.

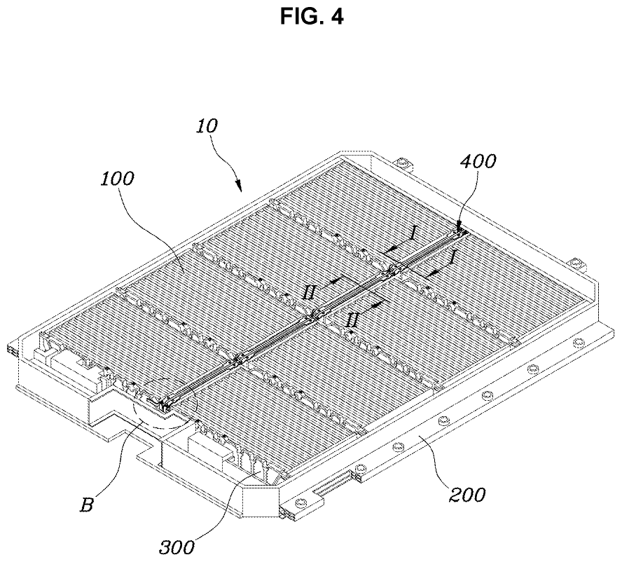

Hereinbelow, referring to FIGS. 1 to 3, based on the above-described components of the battery pack 10 for a vehicle of the present disclosure, a fastening method or a fastening form of each component will be described with reference to FIGS. 4 to 8.

FIG. 4 is a perspective view showing the battery pack for a vehicle with an opened upper cover according to an embodiment of the present disclosure.

FIG. 4 shows the multiple battery modules 100, the first cross members 300, and the second cross member 400 according to the embodiment of the present disclosure, which are placed in and mounted to the lower casing 200 to form the battery pack 10 for a vehicle. Hereinbelow, for convenience of description, the battery pack 10 for a vehicle will be described without an upper cover (not shown), as shown in FIG. 4.

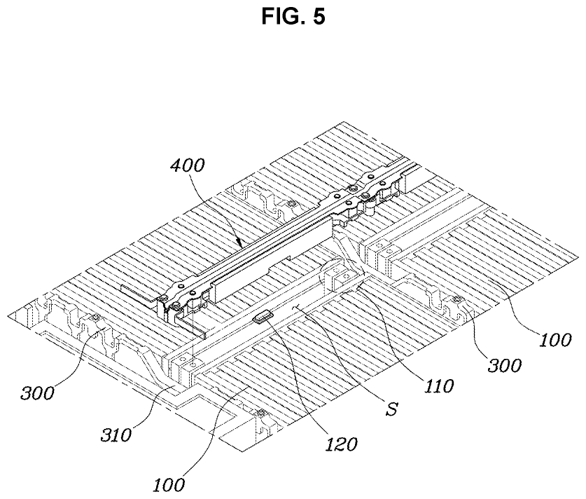

FIG. 5 is a view showing the second cross member placed on a lower casing in which a battery module and a first cross member are placed according to an embodiment of the present disclosure.

Referring to FIG. 5, the battery modules arranged adjacent to each other in the width direction are spaced apart from each other at a predetermined interval to form a gap space S, and the second cross member 400 may be arranged by being inserted into an upper portion of the gap space S. Accordingly, the second cross member 400 may cover the gap space S formed between the battery modules arranged adjacent to each other in the width direction.

Furthermore, the respective terminal parts 110 of the battery modules arranged adjacent to each other in the width direction may face each other toward the gap space S. When the first cross member 300 and the second cross member 400 are fastened to each other, the second cross member 400 may be electrically connected to the terminal part 110 of the battery module 100.

For example, the battery module 100 may include the terminal part 110 and a sensing connector 120 at upper portions of a side surface facing the second cross member 400. The terminal part 110 may be provided at each of front and rear portions of the upper portion of the side surface of the battery module 100 and the sensing connector 120 may be provided between the front and rear terminal parts 110. Accordingly, the second cross member 400 may include the high-voltage bus bar 410 at front and rear portions to correspond to the front and rear terminal parts 110 of the battery module 100, and the sensing device 420 may be provided between the front and rear high-voltage bus bars 410.

Furthermore, the battery modules arranged adjacent to each other in the longitudinal direction may be arranged such that the respective terminal parts 110 may be adjacent to the first cross member 300 inserted between the battery modules arranged adjacent to each other in the longitudinal direction. The high-voltage bus bar 410 of the second cross member 400 may connect the respective terminal parts 110 of the different battery modules to each other, the terminal parts 110 being adjacent to the first cross member 300.

Next, FIG. 6 is a view showing an enlarged part B of FIG. 4.

Referring to FIG. 6, the first cross member 300 and the second cross member 400 may be fastened to each other by the fixing bolt 480. Specifically, the first cross member 300 may include the indentation part 310 on which the second cross member 400 is placed, and the bushing 470 of the second cross member 400 may be placed on the indentation part 310. The fixing bolt 480 may pass through both the cover plate 440 and the bushing 470 of the second cross member 400 to be fastened to the indentation part 310 of the first cross member 300.

Meanwhile, referring to FIG. 6, the high-voltage bus bar 410 of the second cross member 400 may be formed to extend in the width direction. For example, the part “B” in FIG. 4 may be a front portion of the battery pack 10 and components such as a connector and a power relay assembly (PRA) may be provided at the front portion of the battery pack 10, and for connection with the components, the high-voltage bus bar 410 of the second cross member 400 located at the front part of the battery pack 10 may be formed to extend in the width direction. However, this configuration is proposed as an example and is not limited thereto.

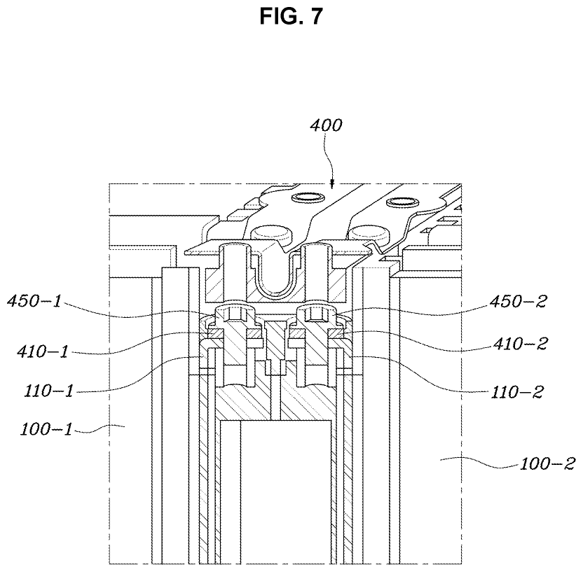

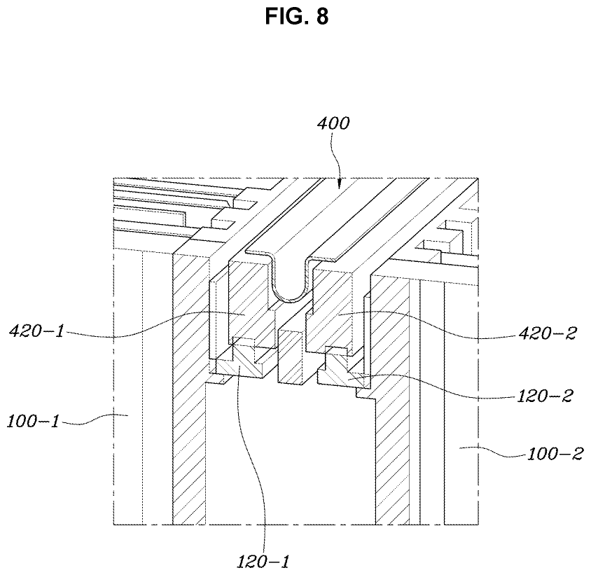

Next, referring to FIGS. 7 and 8, connection between the battery module 100 and the second cross member 400 will be described.

FIG. 7 is a sectional view taken along line I-I of FIG. 4. FIG. 8 is a sectional view taken along line II-II of FIG. 4.

When the first cross member 300 and the second cross member 400 are fastened to each other, the terminal part 110 and the high-voltage bus bar 410 of the second cross member 400 may be connected to each other, and the sensing connector 120 and the sensing device 420 of the second cross member 400 may be connected to each other.

Accordingly, referring to FIG. 7, the second cross member 400 may be provided between the battery modules 100-1 and 100-2 placed adjacent to each other in the width direction. The terminal part 110-1 of the first battery module 100-1 and the high-voltage bus bar 410-1 of the second cross member 400 corresponding to the terminal part 110-1 may be connected to each other by the terminal fastening bolt 450-1. Furthermore, the terminal part 110-2 of the second battery module 100-2 may also be connected to the high-voltage bus bar 410-2 of the second cross member 400 corresponding to the terminal part 110-2 by the terminal fastening bolt 450-2. Furthermore, a lower portion of the terminal part 110 may include a separate fastening part (not shown) to fasten and fix the terminal fastening bolt 450.

Meanwhile, as described above, the insulating cover 460 may be provided between the cover plate 440 and the terminal fastening bolt 450 of the second cross member 400 for insulation. The insulating cover 460 may be formed on the cover plate 440 by insert-injection molding. At this point, the insulating cover 460 may be formed in a form with a vertically perforated center portion. As the center portion of the insulating cover 460 is perforated, a fastening means may be inserted into the perforated portion and fastening between the terminal fastening bolt 450 and the fastening part may be efficiently performed.

Next, referring to FIG. 8, the sensing connector 120 has a form of a male connector and a lower portion of the sensing device 420 has a female connector at a location corresponding to the sensing connector 120 so that the sensing connector 120 and the sensing device 420 may be connected to each other by coupling between the male and female connectors. For example, the sensing connector 120-1 provided in the first battery module 100-1 and the sensing device 420-1 of the second cross member 400 corresponding to the sensing connector 120-1 may be connected to each other by coupling of connectors, and the sensing connector 120-2 provided in the second battery module 100-2 and the sensing device 420-2 of the second cross member 400 corresponding to the sensing connector 120-2 may be connected by coupling of connectors.

Referring to FIGS. 7 and 8, as the second cross member 400 is inserted into the gap space S formed between the battery modules arranged adjacent to each other in the width direction, and is connected to both the first cross member 300 and the battery module 100, the gap space S may be covered, and may have the height similar to the height where the multiple battery modules 100 are placed in the lower casing 200.

In other words, even if the second cross member 400 is connected to the upper portion of the first cross member 300, the second cross member 400 may be inserted maximally to the height similar to the height of the battery module 100 and may be connected to the battery module 100. Accordingly, when the upper cover (not shown) covers the lower casing 200 to which the battery module 100, the first cross member 300, and the second cross member 400 are mounted, a gap between the upper cover and the battery module 100 can be minimized, and the size of the battery pack 10 can be minimized.

Meanwhile, referring to FIGS. 7 and 8, even if the second cross member 400 is fastened, the gap space S may still exist under the second cross member 400. The gap space S may be used as a mounting space for a bus bar for power supply. For example, the battery pack 10 for a vehicle according to the embodiment of the present disclosure may include the connector and the PRA at the front portion thereof, but depending on vehicle requirements, it is necessary to provide the components not at the front portion but at the rear portion. In this case, a bus bar should be connected to supply power from the front PRA to the rear connector, and with using the gap space S described above, the bus bar is prevented from being exposed outwards, resulting minimization of damages, and the rear connector and the front PRA may be stably connected to each other.

According to the above description, the battery pack for a vehicle of the present disclosure can maximize the number of battery cells mounted to the battery pack to maximize a cruising range of a vehicle.

Even if subordinate components are reduced, the structural rigidity of the battery pack can be sufficiently secured by the first cross member and the second cross member inserted between the battery modules, and therefore the structural safety can be improved.

As the first cross member is inserted and the second cross member is fastened to the first cross member at the upper portion of the first cross member, connection between the first cross member and the second cross member can be secured.

Although the present disclosure was provided above in relation to specific embodiments shown in the drawings, it is apparent to those skilled in the art that the present disclosure may be changed and modified in various ways without departing from the scope of the present disclosure, which is provided in the following claims.

Accordingly, the above detailed description should not be construed as limiting in all respects and should be considered illustrative. The scope of the present disclosure should be determined by reasonable interpretation of the accompanying claims, and all changes within the equivalent scope of the present disclosure is included in the scope of the present disclosure.

1. A battery pack for a vehicle, the battery pack comprising:
a lower casing including a plurality of battery modules positioned in a longitudinal direction, wherein a terminal part of a first battery module of the plurality of battery modules and a terminal part of a second battery module of the plurality of battery modules face each other in a width direction;
a first cross member crossing the lower casing in the width direction, and inserted between two adjacent battery modules in the longitudinal direction; and
a second cross member crossing the lower casing in the longitudinal direction, fastened to an upper end of the first cross member so as to be positioned between adjacent battery modules in the width direction, and electrically connected to a terminal part of each of the adjacent battery modules.

2. The battery pack of claim 1, wherein the adjacent battery modules in the width direction are spaced apart from each other by a predetermined distance to form a gap space, and the second cross member is positioned in an upper portion of the gap space.

3. The battery pack of claim 2, wherein the upper end of the first cross member has an indentation part having a depressed form, and the indentation part is formed at the second cross member, and the second cross member is placed in the indentation part and is fastened to the first cross member.

4. The battery pack of claim 2, wherein the second cross member covers the gap space formed between the adjacent battery modules the width direction.

5. The battery pack of claim 1, wherein each of the plurality of battery modules comprises a terminal part and a sensing connector at an upper portion of a side surface facing the second cross member, the second cross member comprises a sensing device monitoring the battery module, and a high-voltage bus bar connecting the battery module to an adjacent battery module, and when the first cross member and the second cross member are fastened to each other, the sensing device and the sensing connector are connected to each other and the high-voltage bus bar and the terminal part are connected to each other.

6. The battery pack of claim 5, wherein an upper portion and a rear portion of the side surface of each of the plurality of battery modules comprise terminal parts, and the sensing connector is provided between the front and rear terminal parts, and a front portion and a rear portion of the second cross member comprise high-voltage bus bars, to correspond to the terminal parts of each of the plurality of battery modules, and the sensing device is positioned between the front and rear high-voltage bus bars.

7. The battery pack of claim 5, wherein the adjacent battery modules in the longitudinal direction are arranged such that terminal parts of each of the adjacent battery modules are adjacent to the first cross member, and the high-voltage bus bar connects the terminal parts of the adjacent battery modules adjacent to the first cross member, to each other.

8. The battery pack of claim 5, wherein the second cross member comprises:
a member body extending in the longitudinal direction of the lower casing, and to which the sensing device and the high-voltage bus bar are mounted; and
a cover plate extending in the longitudinal direction of the lower casing and covering an upper portion of the member body.

9. The battery pack of claim 8, wherein the member body is formed of a plastic material and the cover plate is formed of a metal material.

10. The battery pack of claim 8, wherein the adjacent battery modules in the longitudinal direction are arranged such that terminal parts of each of the adjacent battery modules are adjacent to the first cross member, and the high-voltage bus bar connects the terminal parts of the adjacent battery modules adjacent to the first cross member, to each other, and a terminal fastening bolt fastening the high-voltage bus bar and the terminal part to each other is inserted into the member body, and a plastic insulating cover is provided between the terminal fastening bolt inserted in the member body and the cover plate.

11. The battery pack of claim 10, wherein the high-voltage bus bar is insulated from the cover plate by being covered with the member body.

12. The battery pack of claim 10, wherein a bushing is integrally molded with the member body at a location adjacent in the longitudinal direction to a location into which the terminal fastening bolt is inserted, and the cover plate is fastened to the upper end of the first cross member via the bushing together with the member body.

13. The battery pack of claim 12, wherein the member body comprises the bushing that is integrally molded at a location between locations into which the terminal fastening bolt and another terminal fastening bolt are inserted.

14. The battery pack of claim 12, wherein the high-voltage bus bar comprises an inserting part into which the terminal fastening bolt is inserted, and a connecting part connected to the inserting part while bypassing the bushing.
